(19) United States
(12) Patent Application Publication
(10) Pub. No.: US 2019/0320243 A1
(43) Pub. Date: Oct. 17, 2019

(54) SYSTEM AND METHOD FOR CATEGORIZING MOTION AND MONITORING USER'S PROFILE BY EMPLOYING NON-INTRUSIVE SENSOR

(71) Applicant: Aryan Chauhan, New Delhi (IN)

(72) Inventor: Aryan Chauhan, New Delhi (IN)

(21) Appl. No.: 16/294,180

(22) Filed: Mar. 6, 2019

(30) Foreign Application Priority Data
Apr. 16, 2018 (IN) 201811014418

(51) Int. Cl. H04Q 9/00; E06B 7/28; H04L 29/08

(52) U.S. Cl. CPC H04Q 9/00; E06B 7/28; G08B 21/043; H04L 67/306; H04L 67/12

(57) ABSTRACT

The present invention relates to a system and method for categorizing the motion and monitoring the user's profile by employing non-intrusive sensor. The categorization of motion is performed by user's action, wherein user's action includes at least one of a door lock/unlock, IoT enabled home security and a surveillance. The system comprises a non-intrusive sensor, a processing unit, a memory and a battery. The non-intrusive sensor is attached to a door to detect the movement of the initial speed, swing speed and a stop speed of the user. The processing unit is configured to process the signal from the non-intrusive sensor using signal processing and machine learning technique. The memory stores user profile information by the movement of the door action by the user. The battery is configured to supply energy source to system.

### CROSS-REFERENCE TO RELATED APPLICATIONS

The present applications claims priority from Indian Application No: 201811014418, filed Apr. 16, 2018, herein incorporated by reference in its entirety.

### BACKGROUND

The present invention relates to door lock/unlock system for categorizing motion and monitoring user's profile by employing non-intrusive sensor.

Generally, Internet of things (IoT) is based on connecting every device to internet, thus making the entire system smart, reliable and efficient. IoT allows objects to be sensed and controlled across the existing network infrastructure.

In modern days, IoT brings a significant change in human lives due to sensory devices in home, commercial places, office or body gadgets.

Generally, intrusive sensors such as camera, microphone etc are used for categorizing the motion and monitoring the user's profile. However, the usage of intrusive sensor leads to many security issues. In order to overcome these security issues, non-intrusive sensors or inertial sensors such as accelerometer, gyroscope, temperature sensor are most widely acceptable in a homebased scenario while non-intrusive sensors try to leverage the IoT technologies and principles to enhance user experience.

For example, the US patent document U.S. Pat. No. 6,940,397B1 discloses a vehicle surveillance system. The vehicle surveillance system of the invention relates to the security system for remote locking and unlocking the door. However, the vehicle surveillance system as disclosed in the invention provides a video recording of an interior of a vehicle upon detection of an unauthorized entry into the vehicle by using surveillance system. However, this system does not provide privacy and is associated with violation issues.

Therefore, there exists a need of a system and method for categorizing and monitoring the user's profile.

### SUMMARY OF THE INVENTION

Provided herein are systems, methods and compositions for a door lock/unlock system to categorize the motion and monitor the user's profile, the system (100) comprising: a non-intrusive sensor (102) attached on a door (103) to detect the movement of the door (103); a processing unit (105) configured to process the signal from non-intrusive sensor (102) using signal processing and machine learning algorithm; a memory (106) configured to store the user profile information due to movement of the door action by the user (104); and a battery (107) configured to supply power to the system (100).

The methods, systems, and apparatuses are set forth in part in the description which follows, and in part will be obvious from the description, or can be learned by practice of the methods, apparatuses, and systems. The advantages of the methods, apparatuses, and systems will be realized and attained by means of the elements and combinations particularly pointed out in the appended claims. It is to be understood that both the foregoing general description and the following detailed description are exemplary and explanatory only and are not restrictive of the methods, apparatuses, and systems, as claimed.

### BRIEF DESCRIPTION OF THE DRAWINGS

The forgoing and other features of embodiment will become more apparent from the following detailed description of embodiments when read in conjunction with the accompanying drawings. In the drawings, like reference numerals refer to like elements.

FIG. 1 illustrates a system for detecting the door closing action from the open action of the user by non-intrusive sensor, in accordance to one or more embodiments of the present invention.

FIG. 2(a) illustrates a door with a non-intrusive sensor for the detection of the user's action, in accordance to one or more embodiments of the present invention.

FIG. 2(b) illustrates a block diagram for door-lock/unlock system, in accordance to one or more embodiments of the present invention.

FIG. 3 illustrates the working example of the system, in accordance to one or more embodiments of the present invention.

FIG. 4 illustrates the working example of the system, in accordance to one or more embodiments of the present invention.

### DETAILED DESCRIPTION OF THE INVENTION

The foregoing and other features and advantages of the invention are apparent from the following detailed description of exemplary embodiments, read in conjunction with the accompanying drawings. The detailed description and drawings are merely illustrative of the invention rather than limiting, the scope of the invention being defined by the appended claims and equivalents thereof.

Embodiments of the invention will now be described with reference to the Figures, wherein like numerals reflect like elements throughout. The terminology used in the description presented herein is not intended to be interpreted in any limited or restrictive way, simply because it is being utilized in conjunction with detailed description of certain specific embodiments of the invention. Furthermore, embodiments of the invention may include several novel features, no single one of which is solely responsible for its desirable attributes or which is essential to practicing the invention described herein. The words proximal and distal are applied herein to denote specific ends of components of the instrument described herein. A proximal end refers to the end of an instrument nearer to an operator of the instrument when the instrument is being used. A distal end refers to the end of a component further from the operator and extending towards the surgical area of a patient and/or the implant.

The use of the terms “a” and “an” and “the” and similar referents in the context of describing the invention are to be construed to cover both the singular and the plural, unless otherwise indicated herein or clearly contradicted by context. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Recitation of ranges of values herein are merely intended to serve as a shorthand method of referring individually to each separate value falling within the range, unless otherwise indicated herein, and each separate value is incorporated into the specification as if it were individually recited herein. The word “about,” when accompanying a numerical value, is to be construed as indicating a deviation of up to and inclusive of 10% from the stated numerical value. The use of any and all examples, or exemplary language (“e.g.” or “such as”) provided herein, is intended merely to better illuminate the invention and does not pose a limitation on the scope of the invention unless otherwise claimed. No language in the specification should be construed as indicating any nonclaimed element as essential to the practice of the invention.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

As used herein the term “method” refers to manners, means, techniques and procedures for accomplishing a given task including, but not limited to, those manners, means, techniques and procedures either known to, or readily developed from known manners, means, techniques and procedures by practitioners of the chemical, pharmacological, biological, biochemical and medical arts. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

The present invention overcomes the drawbacks of the prior art by providing a door opening and closing action for categorizing the motion and monitoring user profile by using non-intrusive sensor.

The system of the present invention comprises a non-intrusive sensor, a processing unit, a memory and a battery. The non-intrusive sensor is attached on a door to detect the movement of the initial speed, swing speed and a stop speed of the user. The processing unit is configured to process the signal from the non-intrusive sensor using signal processing and machine learning technique. The memory is configured to store the user profile information by the movement of door action by the user. The battery is configured to supply the energy source to the system.

In accordance to one embodiment of the present invention, the method for categorizing the motion and monitoring the user's profile by non-intrusive sensor comprises the steps of monitoring the movement of the door by the user and gathering the data. The gathered data is extracted by feature extraction algorithm, then the gathered data is stored on cloud storage.

Thus, the invention categorizes the motion and monitoring the user's profile information by the movement of door opening and closing by the user using non-intrusive sensor. Further, the system provides security and privacy to enhance user's experience.

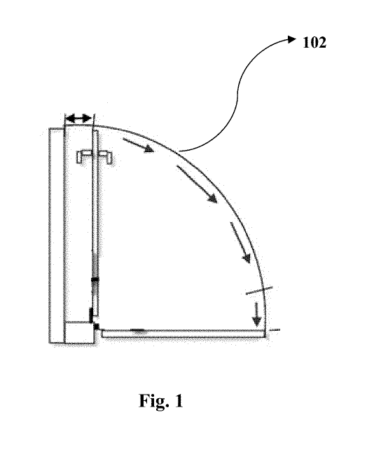

FIG. 1 illustrates a system for detecting the door closing action from the open position of the user by non-intrusive sensor, in accordance to one or more embodiment of the present invention. For this determination, the system (100) comprises a non-intrusive sensor (102), or inertial sensor attached to a door (103) to detect the movement of the initial speed, swing speed, latching speed or stop speed of the user (104), wherein the user (104) is referred as a classifier.

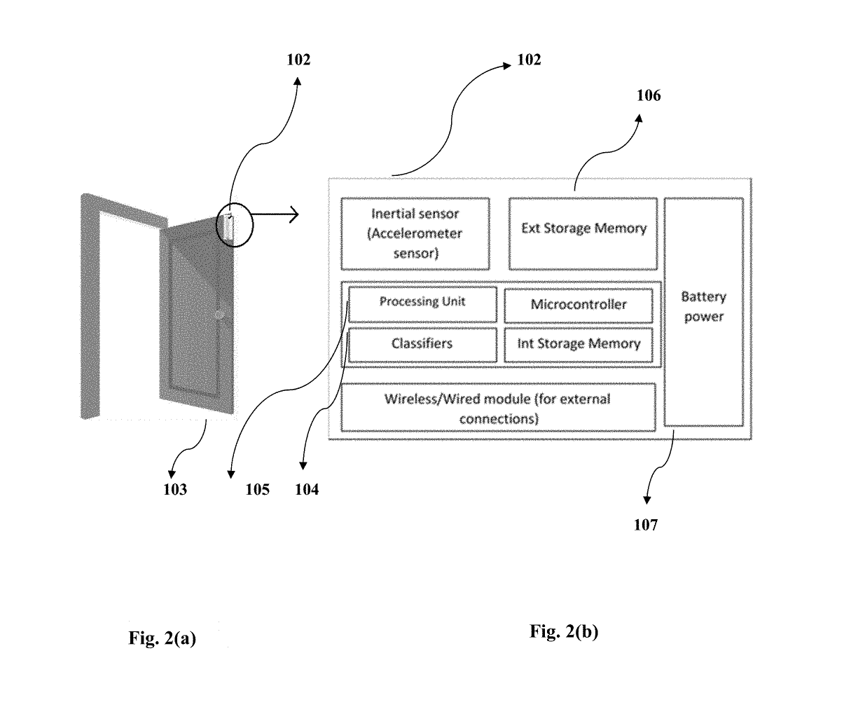

FIG. 2(a) illustrates a door (103) with a non-intrusive sensor (102) for the detection of the user's action, in accordance to the one or more embodiments of the present invention.

FIG. 2(b) illustrates a block diagram for door lock/unlock system in accordance to one or more embodiment of the present invention. As shown in FIG. 2 (b) the system comprises a non-intrusive sensor (102) a processing unit (105), a memory (106), a battery (107). The processing unit (105) executes various instructions and implements the functionality by a non-intrusive sensor (102) using signal processing and machine learning techniques. The memory (106) stores the instructions as well as other data used by processing unit (105) and stores the user specific information such as user profile information. Additionally, memory (106) stores the other data based on the user's detection, wherein the other data are based on the time of the day, day of the week and in synchronization with the calendar. A battery (107) is used to supply energy to the system.

In a preferred embodiment of the invention, the system (100) comprises a non-intrusive sensor (102). The non-intrusive sensor (102) comprises an accelerometer sensor that monitors movement of the door (103). The movement of the door (103) includes a door closing and opening action of a user (104), physical swing of a user (104) and a latching speed of a user (104). The movement of a door (103) from the non-intrusive sensor (102) further includes IoT enabled home security and a surveillance by the user's action. Further, the system (100) records and analyses the data on the memory (106). Furthermore, the non-intrusive sensor (102) further comprises any kind of accelerometer and at least one temperature sensor and a gyroscope or any other sensor for environment inputs for detecting the motion of the user (104).

In accordance to one embodiment of the present invention, the method for categorizing the motion and monitoring the user's profile by non-intrusive sensor (102) comprises the steps of monitoring the movement of the door (103) by the user (104) and gathering the data. The gathered data is extracted by feature extraction algorithm and signal processing. The extracted data is stored in cloud storage. The signal processing feature includes at least one of a rise time, peak swing, total swing time or a stop fall time of the door action by the user (104).

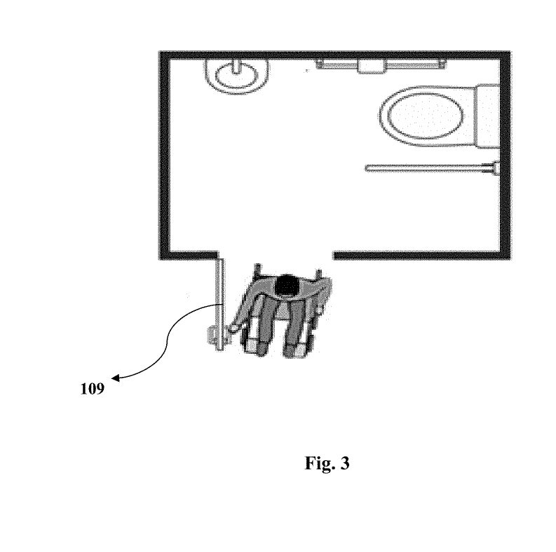

In one embodiment of the present invention, as referred in FIG. 3, a bathroom door (109) with accelerometer sensor is used to provide security for the user during unfortunate fall on the floor, wherein an accelerometer sensor senses the incident and triggers the signal to siren or alarm, which helps to identify the user (104).

In accordance to one embodiment of the present invention, the method also determines current environment conditions such as temperature control and an ambient light level. For instance, a temperature sensor senses the current temperature of the room and detects the movement of the door (103) by the user (104).

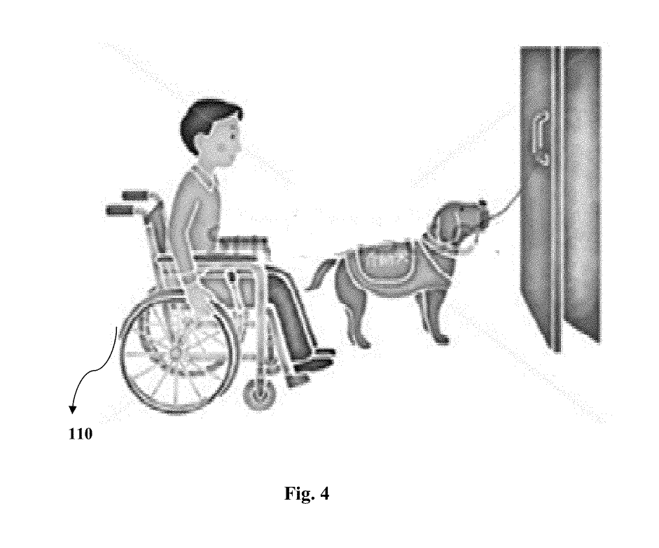

In one embodiment of the present invention, as referred in FIG. 4, a gyroscope sensor (110) detects the movement of a door body (103) by the user (104) and stores the information in the memory (106).

Thus, the present invention categorizes the motion and monitoring the user's profile information by the movement of door lock/unlock by the user (104), using non-intrusive sensor (102).

Thus, the many features and advantages of the invention are apparent from the detailed specification and thus, it is intended by the appended claims to cover all such features and advantages of the invention, which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

While the present invention has been illustrated by a description of various preferred embodiments and while these embodiments have been described in some detail, it is not the intention of the applicants to restrict or in any way limit the scope of the appended claims to such detail. Additional advantages and modifications will readily appear to those skilled in the art. The various features of the invention may be used alone or in numerous combinations depending on the needs and preferences of the user. This has been a description of the present invention, along with the

As used in this application, the terms algorithm and “system” are intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

Generally, program algorithms include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the innovation may also be practiced in distributed computing environments where certain tasks are performed by remote processing devices that are linked through a communications network. In a distributed computing environment, program algorithms can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes volatile and nonvolatile, removable and non-removable media implemented in any method or technology for storage of information such as computer-readable instructions, data structures, program algorithms or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, algorithms or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

Software includes applications and algorithms. Software may be implemented in a smart phone, tablet, or personal computer, in the cloud, on a wearable device, or other computing or processing device. Software may include logs, journals, tables, games, recordings, communications, SMS messages, Web sites, charts, interactive tools, social networks, VOIP (Voice Over Internet Protocol), e-mails, and videos.

In some embodiments, some or all of the functions or process(es) described herein and performed by a computer program that is formed from computer readable program code and that is embodied in a computer readable medium. The phrase “computer readable program code” includes any type of computer code, including source code, object code, executable code, firmware, software, etc. The phrase “computer readable medium” includes any type of medium capable of being accessed by a computer, such as read only memory (ROM), random access memory (RAM), a hard disk drive, a compact disc (CD), a digital video disc (DVD), or any other type of memory.

All publications and patent applications mentioned in this specification are herein incorporated by reference to the same extent as if each individual publication or patent application was specifically and individually indicated to be incorporated by reference.

While the invention has been described in connection with various embodiments, it will be understood that the invention is capable of further modifications. This application is intended to cover any variations, uses or adaptations of the invention following, in general, the principles of the invention, and including such departures from the present disclosure as, within the known and customary practice within the art to which the invention pertains.

What is claimed is:

1. A system for door lock/unlock to categorize the motion and monitor the user's profile, the system comprising:
a. a non-intrusive sensor attached on a door to detect the movement of the door;
b. a processing unit configured to process the signal from non-intrusive sensor using signal processing and machine learning algorithm;
c. a memory configured to store the user profile information due to movement of the door action by the user; and
d. a battery configured to supply power to the system.

2. The system as claimed in claim 1, wherein movement of the door includes at least one of a door opening and closing motion, the physical swing of the door.

3. The system as claimed in claim 1, wherein movement of the door from the non-intrusive sensor by user's action includes a door lock/unlock movement.

4. The system as claimed in claim 3, wherein user's action further includes at least one of an IoT enabled home security and a surveillance.

5. The system as claimed in claim 1, wherein the machine learning algorithm dynamically classifies the user's profile information for the user's identification.

6. The system as claimed in claim 1, wherein the non-intrusive sensor comprises of any kind of accelerometer and at least one temperature sensor and a gyroscope or any other sensor for environment inputs for detecting the motion of the user.

7. The system as claimed in claim 1, wherein the profile information includes combination of data such as a time of day, day of the week and synchronization with calendars of the user.

8. A method for categorizing motion and monitoring user's profile by employing non-intrusive sensor, the method comprises the steps of:
a. monitoring the movement of the door to detect the initial speed, swing speed of the user by a non-intrusive sensor;
b. gathering the user's data and extracting the signal processing feature by feature extraction algorithm; and
c. storing the extracted data on cloud storage.

9. The method as claimed in claim 8, wherein signal processing feature includes at least one of a rise time, peak swing, total swing time and a stop fall time of the door action by the user.

10. The method as claimed in claim 8, wherein the user movement based on the environment inputs on IoT devices includes at least one of a temperature sensor, a gyroscope or any other sensor for detecting the motion of the user.
